(19) United States
(12) Patent Application Publication
(10) Pub. No.: US 2010/0036677 A1
(43) Pub. Date: Feb. 11, 2010

(54) COMPUTERIZED SETTLEMENT AND INVOICE VALIDATION SYSTEM FOR HEALTHCARE SERVICES

(75) Inventors: Raymond William Daub, JR., Louisville, KY (US); Ramu Shankaran Kannan, Acton, MA (US)

Correspondence Address: STANDLEY LAW GROUP LLP, 6300 Riverside Drive, Dublin, OH, 43017, US

(73) Assignee: Humana Inc., Louisville, KY (US)

(21) Appl. No.: 12/233,986

(22) Filed: Sep. 19, 2008

Related U.S. Application Data
(63) Continuation of application No. 61/086,996, filed on Aug. 7, 2008.

(51) Int. Cl. G06Q 10/00

(52) U.S. Cl. 705/2

(57) ABSTRACT

A computerized settlement and invoice validation application that enables a payor to validate the charges from a healthcare services provider and to better manage contracting and performance management functions. The application supports claims adjudication and payment processing. It validates all patient activity data that is received from healthcare services providers. Patient activity data relates to episodes involving a single patient care event. The application applies to episodes rules related to clinical and financial requirements for the payor. The application tracks details related to application of the rules to episodes and identifies reasons that an episode fails. Episodes that fail are routed to appropriate staff for review and action. Following review, an episode may be accepted for payment or challenged for various reasons. The application automates a variety of manual tasks and limits manual review to only those activities that require further attention and action.

### CROSS-REFERENCE TO RELATED APPLICATIONS

This application claims priority to U.S. Provisional Patent Application Ser. No. 61/086,996, filed Aug. 7, 2008, titled COMPUTERIZED SETTLEMENT AND INVOICE VALIDATION SYSTEM FOR HEALTHCARE SERVICES, which is incorporated herein by reference.

### FIELD OF THE INVENTION

The present invention relates to computerized applications for settlement and validation of claims for healthcare services. In particular, the present invention relates to a computerized settlement and invoice validation application for use by payors to accept or challenge claims for healthcare services according to clinical and financial rules.

### BACKGROUND OF THE INVENTION

In many healthcare systems throughout the world, third-party payors administer and offer programs for providing basic health care services to individuals within a specific community. In countries where nationalized health services are offered, the payor is governmental agency or entity entrusted to provide healthcare services to all citizens in the country at the government's expense. Such payors typically contract with service providers in geographic areas throughout the country to provide the healthcare services. Charges for services are forwarded to the payor that then reviews and pays the service provider for the services rendered. In most healthcare systems, individuals typically see a doctor, dentist, optician, pharmacist, or other primary healthcare service provider when they first experience a particular health problem. To make primary care services available within a particular geographic region, payors may contract with various healthcare services providers to operate walk-in centers or clinics as well as provide phone services. Payors typically work with local healthcare services providers as well as local authorities and other agencies that provide health and social care locally to make sure that a local community's needs are met.

Local, primary care service providers are often at the center of a national health system and often represent 75-80% of the health system budget. Because they are local organizations, they are in the best position to understand the needs of their community and to ensure that they are providing effective health and social care services. For example, they ensure there is an adequate level of service in an area and that the services are accessible to individuals living in the area. They also ensure that the range of services is appropriate. They build and operate facilities such as hospitals, clinics, walk-in centers, and pharmacies as well as staff the facilities with personnel providing medical and dental services, optical services, mental health services, pharmacy services, and even patient transport (including accident and emergency) and population screening services. They coordinate a variety of systems and activities so that they work together for the benefit of patients in an area.

In recent years, national health systems in some countries have adopted “Payment by Result” (PbR) models for payment of claims by governmental payors. The goal of PbRs is to provide a transparent, rules-based system for paying local primary care service providers. They are intended to reward efficiency, support patient choice and diversity, and encourage activity for sustainable waiting time reductions. Payments are linked to activity and adjusted for case mix. The PbR system provides a fair and consistent basis for healthcare funding rather than relying principally on historic budgets and the negotiating skills of individual managers.

With the advent of the Payment by Result (PbR) model, payors are now charged by healthcare services providers for every service rendered (activity) by the provider using either a national agreed upon tariff or locally contracted rates. The fully costed activity data is available to payors through various means. For example, in the United Kingdom, it is available via a national feed or a secondary care data source such as Secondary Usage Services (SUS). Payors are expected to validate this data and resolve disputes or “challenges” before an effective date know as a “Freeze Date.”

In most cases, payors do not have a systematic way of consistently applying the payment and business rules to conform to the PbR model. They also have difficulty in identifying the activities that result in anomalies and therefore, require manual processing by a human being. Most payors process this data either manually or using desktop tools like Microsoft Excel or Access. Because so many individuals are involved in managing payments, the rules may not be applied in a consistent fashion.

### SUMMARY OF THE INVENTION

The present invention is a computerized settlement and invoice validation application that enables payors to validate the charges from a healthcare services provider and to better manage their contracting and performance management functions. The computerized settlement and invoice validation application includes features and functionality for claims adjudication and payment processing. The primary purpose of the settlement and invoice validation application is to help payors validate all patient activity data that is received from the primary care providers. Patient activity data relates to spells (a care event that involves an admission and discharge or transfer from a hospital) and episodes (a single care event). A spell may involve multiple episodes. It applies a set of robust rules in a consistent fashion and when appropriate, provides enough information to a commissioner to challenge the charge (billing) for a particular activity.

The computerized settlement and invoice validation application is capable of processing data feeds from healthcare computer systems that provide data for management and clinical purposes other than direct patient care, such as healthcare planning, clinical governance, performance improvement and medical research. Examples of such data management systems are the United Kingdom's Secondary Uses Services (SUS). The computerized settlement and invoice validation application applies relevant data quality rules to detect incomplete or inaccurate data, loads the data into a relational database, applies various relevant costing and business rules, automatically routes the activities with potential anomalies to payor representatives for review and action (either accept or challenge). It enables the payor to automate a highly manual set of tasks and review only the activities that need further attention and action. The system also provides multiple reports on the activities that need to be challenged, data quality, trends in anomalies by health services provider, and performance management reports.

### BRIEF DESCRIPTION OF THE DRAWINGS

FIGS. 1A and 1B are a flow chart illustrating application of various data quality and business rules to episodes;

FIG. 2 is a flow chart illustrating actions regarding third party data;

FIG. 3 is a screenshot of an inbox for a Challenge Manager;

FIG. 4 is a screenshot of an inbox for an Operations Manager;

FIG. 5 is a screenshot of an inbox for a Clinical Checker;

FIG. 6 is an episode details screen; and

FIG. 7 is a more episode details screen.

### DETAILED DESCRIPTION

Data Inputs: The settlement and invoice validation application accepts secondary care data from various sources in order to validate activity data for various services provided to patients at payor facilities. The secondary data supports the business rules and other requirements for settlement as well as identifying anomalies. In an example embodiment, the settlement accepts secondary care data. In such an embodiment, if the payor desires, other secondary care data feeds (SLAM, PAS, etc.) may be mapped to the database of the settlement and invoice validation application so that it can be imported and used. Other standard data sets that may be required by the application are pre-loaded into the application repository. These standard data sets include, for example, national tariffs based on healthcare resource groups (HRG), diagnostic codes (ICD10), and procedure/treatment codes (e.g., OPCS codes in the United Kingdom, CPT code in the United States). When implementing the settlement and invoice validation application for a particular national healthcare system, local contracts are analyzed and relevant terms are recorded in the application repository. General practitioner (GP) or family physician related data from each payor patient registry may also be stored in the application repository. This approach allows both national and local standards and data to be applied as needed in processing episode data.

In an example embodiment for the national healthcare system of the United Kingdom, data from the following various sources is accepted and stores in one or more application repositories.

TABLE 1
Settlement and Invoice Validation Application Data Sources

| Secondary Care | Application accepts secondary care data as input for validation. | |
|---|---|---|
| Data | | |
| | SUS Data and | ETL layer for mapping SUS data feeds to database |
| | Repository | tables and apply rudimentary data quality checks. |
| | ETL Mapping for SUS | |
| | Data | |
| | SLAM Data and | ETL layer available for mapping SLAM data feeds to |
| | Repository | database tables and apply rudimentary data quality |
| | ETL Mapping for SLAM | checks. |
| | Data | |
| | PAS Data and | ETL layer available for mapping PAS data feeds to |
| | Repository ETL Mapping | database tables and apply rudimentary data quality |
| | for PAS Data | checks. |
| Standard Code | Application stores and uses standard code sets including national tariff codes | |
| Sets | (HRG), diagnosis codes (ICD10) and procedure/treatment codes (OPCS). Multiple | |
| | versions of these code sets are supported. | |
| | Repository for HRG | Appropriate repositories to store and use HRG, |
| | Codes | ICD10, and OPCS data codes. |
| | Repository for ICD10 | |
| | Codes | |
| | Repository for OPCS | |
| | Codes | |
| Implementation | Application stores and uses several data sets relevant to each payor. These data | |
| Data | sets include information about GPs and GP Practices in the patch, information | |
| | about providers, and local contract terms (non-PbR). Data is collected as a part of | |
| | implementation process and updated as needed. | |
| | Repository for GP Data | Appropriate repository stores GP data including |
| | Repository for Provider | practice codes. GP codes and names entries have |
| | Data | start and end dates that are checked by application. |
| | | Appropriate repository stores provider data including |
| | | hospital identifier codes and names. Entries have a |
| | | start and end date checked by application. |
| | Local Contract Terms | Appropriate repository to store local contract terms |
| | | by provider. Entries have start and end date and |
| | | reference to the appropriate contract document. |
| | | Application reads and applies these local contract |
| | | terms wherever appropriate. |
| Automated | Application automatically loads and processes secondary care data as and when it | |
| Loading of | becomes available. If data is not available for a period, application alerts | |
| Secondary Care | appropriate people so that corrective action can be taken. | |
| Data | | |
| | Listener Service | Listener service detects a file when it is available in a |
| | | specific location (directory) and processes it. |
| | Time Based Trigger | Application checks for a file at designated times and |
| | | processes it. |
| | Email Alert | Application send email alerts if a data file is not |
| | | received when expected. |
| Data Quality | Once secondary care data is loaded in application, data is checked to ensure that | |
| Checks | minimal data that is required for application to validate data is available. Activity | |
| | that does not meet these data quality checks is marked appropriately and sent | |
| | back to the provider for correction. Data that fails data quality checks is not | |
| | processed any further. Typical data quality checks include checks for missing data | |
| | in required fields, use of unknown codes, and dates out of range. | |
| | Missing Data Check | Application checks to ensure that data absolutely |
| | | required for proper validation of secondary care data |
| | | is available. If such data is missing, application does |
| | | not process that data any further and has provider |
| | | resend data. |
| | Field Missing Data | Application checks following fields for missing data: |
| | Check | Unique Record ID/Patient ID - each row of data in |
| | | SUS data feed must have a unique record ID |
| | | HRG Code |
| | | ICD10 Code |
| | | OPCS Code |
| | | GP Practice Code |
| | | GP Code |
| | | Hospital/Provider Code |
| | | Episode Date |
| | | Admission Date |
| | | Discharge Date |
| | | Treatment Date |
| | | Episode Identifier |
| | | Spell Identifier |
| | | Birth Date of Patient |
| | | Admission Type |
| | | Admission Source |
| | | Discharge Method |
| | | Referrer Code |
| | Unknown Codes | Application validates codes that are used in each |
| | | episode and ensure they are valid. If any codes are |
| | | invalid, application does not process that episode and |
| | | has provider resend the data. |
| | Wrong Code Check | Application checks if following codes are appropriate |
| | | using data in standard code tables HRG. |
| | | OPCS |
| | | ICD10 |
| | | GP Practice Code |
| | | GP Code |
| | | Referrer Code |
| | | Hospital/Provider Code |
| | Valid Date Check | Application checks to ensure that dates in episode |
| | | are valid. If discharge date is before admission or |
| | | treatment date, application does not process that |
| | | episode and has provider resend data. |
| | Date Consistency Check | Application checks to ensure that discharge date is |
| | | after admission date and treatment date. Application |
| | | checks to ensure that treatment date is after |
| | | admission date. |
| Business Rules | Application applies an entire set of business rules to validate secondary care data. | |
| | Rules include national and local costing rules, checks for duplicate data, out-of- | |
| | area referrals (payor should not pay for these), gender based checks (mismatches | |
| | in which procedure is normally performed on patients of opposite sex), same day | |
| | readmissions (patient should not be admitted twice), minor procedure identification | |
| | (minor surgeries that should be treated as outpatient rather than inpatient), and | |
| | readmission of patients within certain number of days of an emergency admission | |
| | (e.g., 14 or 28; some payors challenge readmissions). Application can also have | |
| | rules to validate that a certain care pathway was followed. Rules can be turned on | |
| | or off based on workload and implementation requirements. If a particular episode | |
| | of data fails a particular rule, it is sent to a designated individual to examine it and | |
| | decide whether to accept it or challenge it. | |
| | Apply Business Rules | Application automatically applies business rules to |
| | Automatically | validate secondary care data. |
| | Business Rules Engine | Application uses a business rules engine that reads |
| | | rules from a repository and applies them in an |
| | | automated fashion. |
| | Turn Rules On/Off | A rule can be turned on or off based on the needs of |
| | | a payor. A disabled rule is not be used in validation |
| | | process. |
| | Database Field to Turn | Each business rule has an associated binary field |
| | Rules On/Off | value that allows a rule to be enabled or disabled. |
| | Rule Categorisation | Rules are grouped into following categories - Clinical |
| | | Validation, Pricing Validation, Invoice Validation, and |
| | | Data Quality. Additional categories may patient and |
| | | GP Eligibility, Duplicate Checking, Pricing |
| | | Adjustments, Pricing Resolution, Financial Recovery |
| | | or Subrogation. A listing of example rule categories |
| | | is provided in Appendix A. |
| | Rule Categories | Each rule has an associated a category. |
| | Challenge Potential | Application marks for challenge episodes that fail one |
| | Invalid Episodes | or more rules. |
| | Mark Failed Rules for | Each episode has one or more flags that are updated |
| | Challenge | when an episode fails a rule. The rule that failed is |
| | | recorded. |
| | Customize Rules for | Application allows each rule to be customisable for |
| | Each Payor | each payor. |
| | Many-to-Many Payor | Relationship between rules and payors are many-to- |
| | Rule Mapping | many. A payor can have many rules. Each rule may |
| | | be used by more than one payor. Application uses a |
| | | mapping table of rules to payor. Entries in this table |
| | | are checked before a rule is applied. |

A detailed listing of example rules is provided in Appendix B.

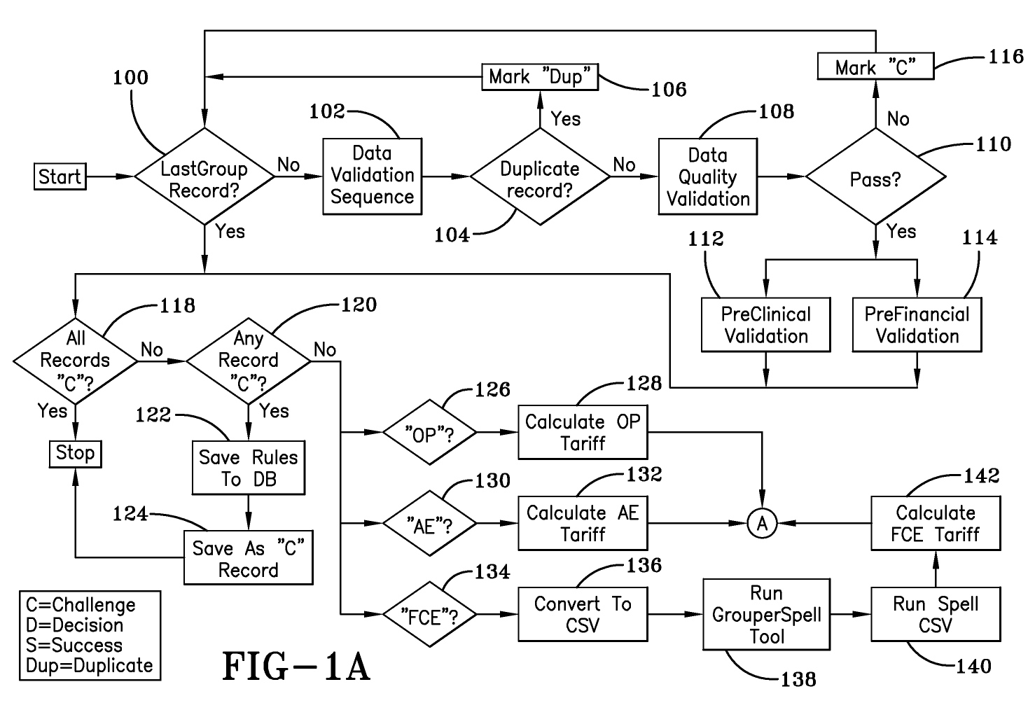

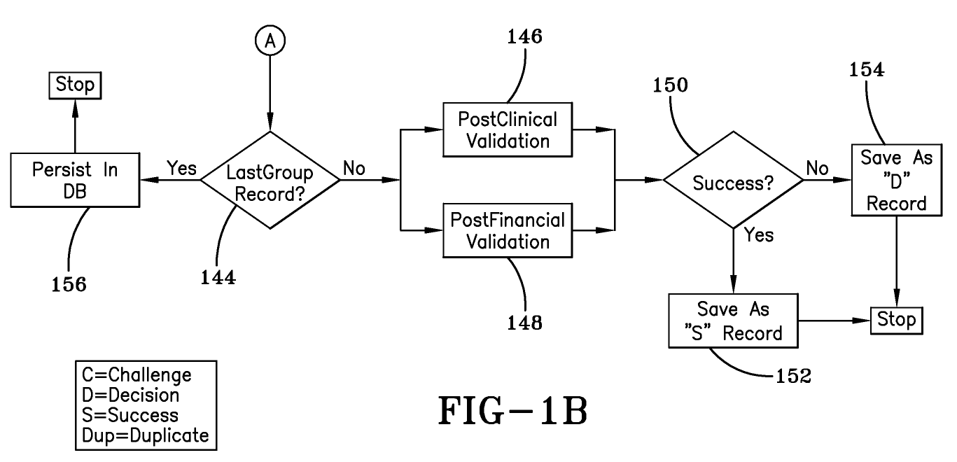

Referring to FIGS. 1A and 1B, a flow chart illustrating application of various data quality and business rules to episodes is shown. Rules are applied to records related to episodes in which care is provided to a patient and data related to the patient's date of birth, sex, diagnosis, procedures, date of treatment, etc. are recorded. Episodes may occur during a spell which involves a stay in a hospital or other healthcare facility and in which information on patient's date of birth, sex, diagnosis, procedures as well as admission and discharge or transfer dates to the hospital or other healthcare facility are recorded. The typical flow of the settlement and invoice validation application is outlined in Table 2.

TABLE 2
Settlement and Invoice Validation Application Flow

| | |
|---|---|
| Load Data | Application accepts secondary source data as input (e.g., secondary care |
| | data) and loads into an application repository. |
| Process Records | Records are processed in groups. Application continues processing |
| 100 (FIG. 1A) | records as long as there are records within the group. |
| Data Validation | A data validation sequence is applied to a record 102. The validation |
| Sequence | sequence confirms that expected data is present in record. |
| 102 (FIG. 1A) | |
| Duplicate Record Check | A record is compared against existing records for an episode 104. A |
| 104 (FIG. 1A) | duplicate record is marked as a duplicate 106. |
| Data Quality Validation | A data quality validation is applied to a record 108. The validation confirms |
| 108 (FIG. 1A) | that data values are within expected ranges or meet other criteria. A record |
| | that does not pass the quality validation step 110 is marked as a “challenge” |
| | 116. The provider is contacted so that problems with the record can be |
| | resolved. |
| PreClinical Validation | A record that passes the quality validation step moves to a preclinical |
| 112 (FIG. 1A) | validation step 112. In preclinical validation, rules related to the patient care |
| | episode are applied to determine whether the care provided complied with |
| | patient care requirements or standards established by the payor. (e.g., was |
| | proper care given?). |
| PreFinancial Validation | A record that passes the quality validation step moves to a pre-financial |
| 114 (FIG. 1A) | validation step 114. In pre-finanical validation, rules related to payments for |
| | the episode are applied to determine whether the charges for the care |
| | provided complied with financial requirements or standards established by |
| | the payor (e.g., pricing validation, invoice validation). |
| Challenge Record Check | A record that fails the preclinical validation step 112 or pre-financial |
| 118 (FIG. 1A) | validation step 114 is marked as a challenge. If all records in the group fail |
| 120 (FIG. 1A) | (are marked “challenge”) 118, processing of the records stops. If any |
| | record in the group fails (is marked “challenge”) 120, data regarding the |
| | reason(s) for failure are recorded in the database 122 and the record is |
| | marked “challenge” 124. |
| Outpatient (OP) Tariff | A record that passes the preclinical validation step 112 and pre-financial |
| 126 (FIG. 1A) | validation step 114 proceeds for processing. If the record relates to an |
| | outpatient episode 130, the appropriate outpatient (OP) tariff is applied 128. |
| | The tariff covers all activity related to the patient care episode (e.g., tests, |
| | drugs, treatment). |
| Accident & Emergency | A record that passes the preclinical validation step 112 and pre-financial |
| (AE) Tariff | validation step 114 proceeds for processing. If the record relates to an |
| 130 (FIG. 1A) | accident or emergency episode 126, the appropriate outpatient (OP) tariff is |
| | applied 132. The tariff covers all activity related to the patient care episode |
| | (e.g., tests, drugs, treatment). |
| Finished Consultant | A record that passes the preclinical validation step 112 and pre-financial |
| Episode (FCE) | validation step 114 proceeds for processing. If the record relates to a |
| 134 (FIG. 1A) | finished consultant episode (FCE) 134, the record is converted for further |
| | processing (e.g., to a comma separated value (CSV) file) 136. Rules |
| | related to spells are applied 138, 140 and the FCE tariff is determined 142. |
| Process Records | Processing of records in the group continues until the last record is |
| 144 (FIG. 1B) | encountered 144. When the last record is encountered, data related to |
| | processing of the records is saved in the database 156. |
| Post Clinical Validation | In post clinical validation 146, records that fail one or more preclinical |
| 146 (FIG. 1B) | validation rules are routed to designated clinical personnel who review the |
| | record and associated data for each episode and decide whether to accept |
| | or challenge it. If the reviewer accepts the record (success - yes) 150, it is |
| | marked “S” for success 152 and processing of the record ends. If the |
| | reviewer decides not to accept the record (success - no) 150, it is marked |
| | “D” for decision 154 and processing of the record ends. |
| Post Financial Validation | In post clinical validation 148, records that fail one or more preclinical |
| 148 (FIG. 1B) | validation rules are routed to designated financial personnel who review the |
| | record and associated data for each episode and decide whether to accept |
| | or challenge it. If the reviewer accepts the record (success - yes) 150, it is |
| | marked “S” for success 152 and processing of the record ends. If the |
| | reviewer decides not to accept the record (success - no) 150, it is marked |
| | “D” for decision 154 and processing of the record ends. |

Workflow & States: The settlement and invoice validation application uses a workflow engine to route the potentially challengeable episodes to designated personnel who can look at the data and associated information for each episode and decide whether to accept or challenge it. The workflow engine is configured to manage challenges as shown in Table 3.

TABLE 3
Settlement and Invoice Validation Application Challenge
Management

| | |
|---|---|
| Data Quality Challenges | Episodes with data quality issues are not routed to anyone for |
| | acceptance or challenge. They are directly marked for challenge. |
| Other Challengeable | All other episodes that fail one or more rules follow a two step workflow |
| Episodes | process. First, they are routed to a subject matter expert depending |
| | on the rule group. Once accepted or marked for challenge by the |
| | subject matter expert, the episode is routed to the challenge manager |
| | who can either agree with or override the subject matter expert. |

Once rules are applied to an episode, it is in one of the states shown in Table 4.

TABLE 4
Episode States

| | |
|---|---|
| First Pass/Clean (FP) State | Episode did not fail a single rule and is clean. |
| Unassigned (UA) State: | Episode failed one or more rules and no subject matter expert is |
| | currently reviewing to decide whether to accept or challenge it. |
| Under Investigation (UI) State | Episode failed one or more rules and a subject matter expert is |
| | currently investigating but has not decided whether to accept or |
| | challenge. |
| Accepted (AC) State | Episode failed one or more rules and a subject matter expert has |
| | decided to accept episode and pay for it. |
| Challenged (CH) State | Episode failed one or more rules and the subject matter expert has |
| | decided to challenge the episode. |

Workflow State Changes: Once an episode is marked for challenge, its state is Unassigned (UA). The episode is then forwarded to the appropriate subject matter expert's electronic inbox. Once a subject matter expert selects an episode for further investigation, the episode state is changed to Under Investigation (UI). Once the subject matter expert decides to accept the episode, its state is changed to Accepted (AE). If the subject matter expert decides to challenge the episode, its state is changed to Challenged (CH).

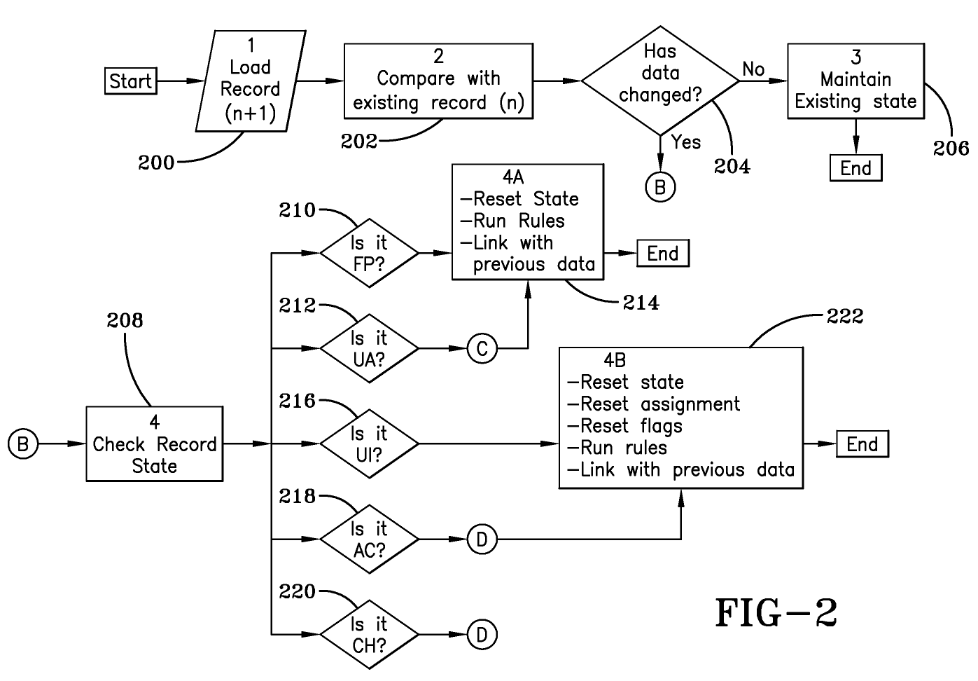

Impact of New Data File on States: Periodically, a payor receives a new data file with updates to the episode data from a third party source (e.g., secondary care data). The settlement and invoice validation application takes one or more actions based on the changes to the data and the current state of the episode within the settlement and invoice validation application. Referring to FIG. 2, a flow chart illustrating actions regarding third party data is shown. The actions are explained in Table 5.

TABLE 5
Third Party Data Updates for Payor

| | |
|---|---|
| Load Records | Each time a new secondary care data file is received, application reads data in |
| 200 | file and loads it into application. |
| Compare with | Application compares episode data in new file with data already loaded in |
| Existing Records | settlement and invoice validation application database from a previously sent |
| 202 | file. Data is checked if to confirm it has changed 204. It is possible that |
| | provider made some adjustments to data based on challenge dialogue with |
| | payor. |
| Maintain Existing | If episode data in new file has not changed, settlement and invoice validation |
| State | application retains existing state in database. |
| 206 | |
| Check Record State | If episode data in new file has changed, settlement and invoice validation |
| 208 | application checks state of episode and takes appropriate action as follows: |
| | FP 210 or UA 212 State: Reset the state and run the rules again. After the |
| | rules are run, episode has a state of FP (no rules were failed) or UI (rules were |
| | failed and is currently unassigned). Link new episode data with the episode |
| | data and decisions that were made. 214 |
| | UI 216, AC 218 or CH 220 State: Reset the state, reset assignment to subject |
| | matter expert, reset all rule flags (which rules the episode failed), and run the |
| | rules again. After rules are run, episode has a state of FP (no rules were |
| | failed) or UI (rules were failed and is currently unassigned). Link new episode |
| | data with old episode data and decisions that were made. 222 |

Application Roles & Privileges: The settlement and invoice validation application supports multiple roles. These roles are outlined in Table 6.

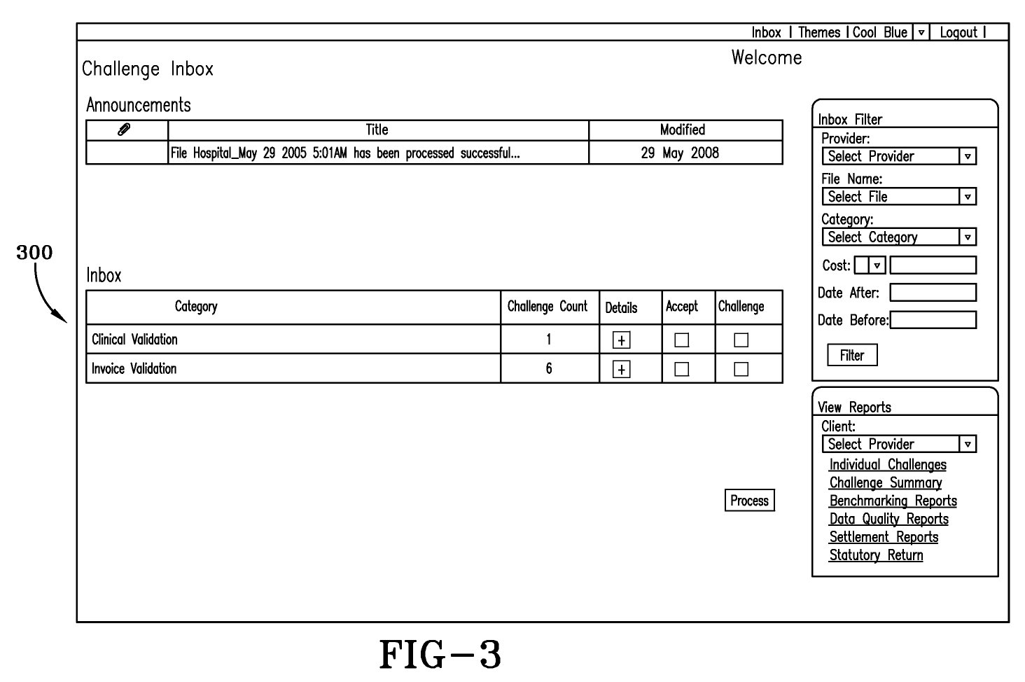

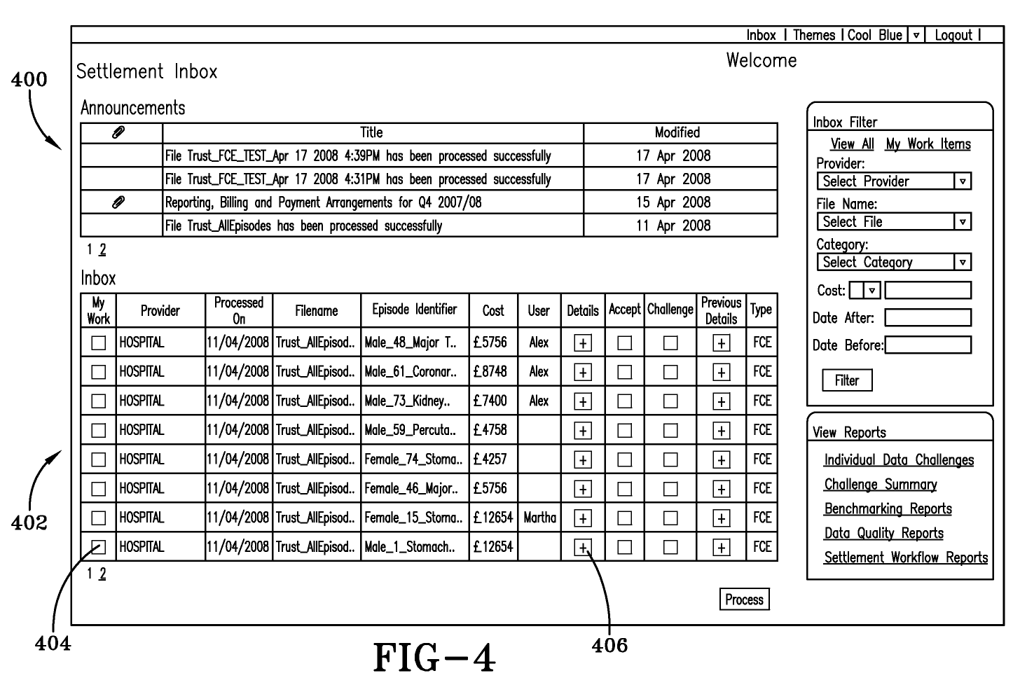

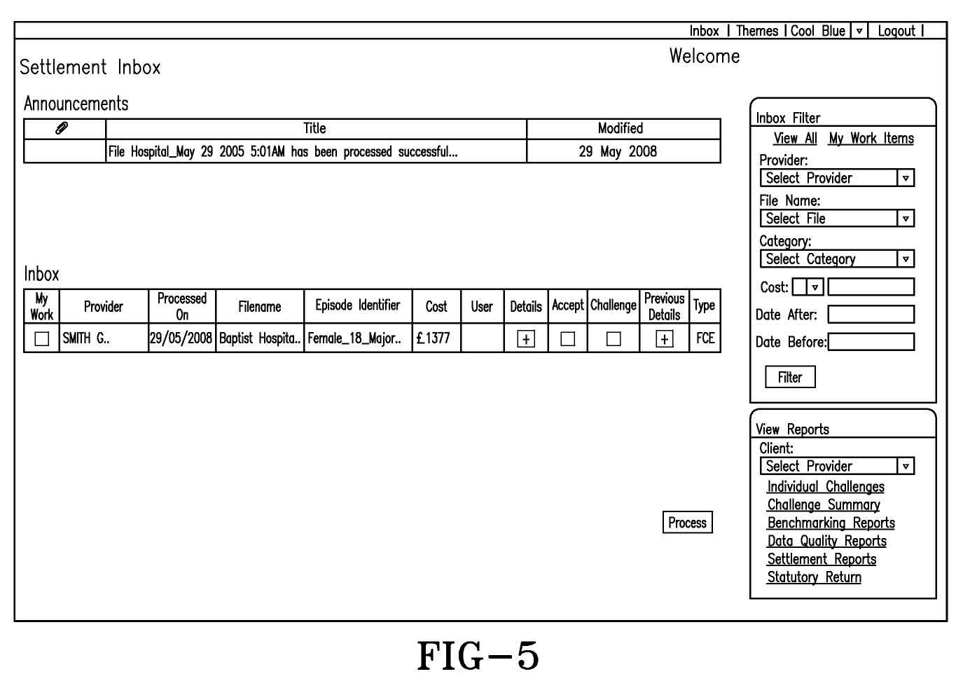

TABLE 6
Settlement and Invoice Validation Application Roles and
Privileges

| | |
|---|---|
| Challenge Manager | Challenge Manager decides whether to accept or challenge an episode. |
| | Challenges/acceptances are routed to Challenge Manager who can override |
| | decisions made by others. Challenge Manager has access to all the reports. |
| | Challenge Manager also works with payor to resolve outstanding challenges. |
| | Referring to FIG. 3, a screenshot of an inbox for a Challenge Manager is |
| | shown. Challenges may be organized according to category (e.g., clinical |
| | validation, invoice validation) 300. |
| Operations Manager | Operations Manager manages daily activities of settlement operations and |
| | monitors invoice and challenge inventory levels. Operations Manager has |
| | access to all episodes that have failed one or more rules. Operations |
| | Manager can accept/challenge episodes and also view all reports. Referring |
| | to FIG. 4, a screenshot of an inbox for an Operations Manager is shown. |
| Subject Matter Experts: | Subject matter experts identify and resolve data quality issues and determine |
| Invoice Checker or | the need for challenges. They also validate episodes. Subject matter |
| Clinical Checker | experts are able to view episodes that fail one or more rules in their subject |
| | area of expertise and decide whether to accept or challenge those episodes. |
| | For example, a clinical checker views episodes that failed one or more |
| | clinical rules. An invoice checker view episodes that failed one or more |
| | financial rules. Subject matter experts may not have access to all reports. |
| | Referring to FIG. 5, a screenshot of an inbox for a Clinical Checker is |
| | shown. |

Inbox Functionality: Users of the settlement and invoice validation application have access to episodes via their web based inbox. The electronic inbox allows them to view the episodes that have failed one or more rules, view associated data and either accept or challenge these episodes. Some of the users can also view various reports via the inbox.

Referring again to FIG. 4, an operations manager screen is shown. The top portion of the screen 400 has announcements. Payors may post one or more announcements for the settlement and invoice validation application users to view. The bottom portion of the inbox screen 402 displays all the episodes that have failed one or more rules. As indicated in FIG. 4, an episode record may have the following fields: provider; process date; filename; episode identifier; cost; details option; accept and challenge indicators; previous details option; and type (OP, AE, FCE). A selection box at left of each episode row 404 allows the user to select episodes for further processing. The selection box may be color coded (e.g., green to indicate that the episode has been assigned to the user and is in process; grey/black to indicate that the episode is unassigned; yellow to indicate another subject matter expert is processing the episode). The user can either accept or challenge the episode based on the summary data available in the inbox screen or select a details option 406 to view more details.

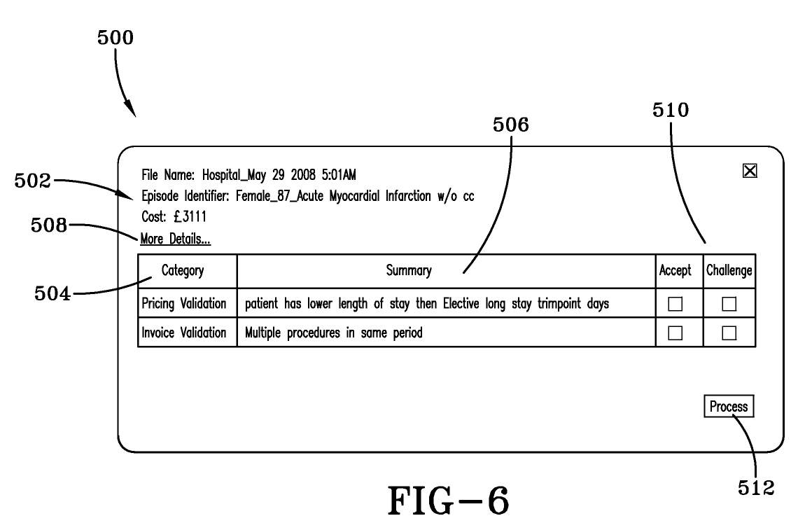

Referring to FIG. 6, an episode details screen is shown. When the details option on the operations manager screen is selected, episode details may be viewed. The episode details screen comprises a section 500 with details for a selected episode. Within the section, identifying information for the episode 502 including the file name, episode identifier, and cost are displayed. It also provides details regarding the reason the episode failed the applicable rules. A failure category 504 and failure reason 506 are displayed. The user can view additional details by selecting a “more details” option 508. Finally, the screen provides accept or challenge options 510. When the user selects the accept or challenge check box, a text box appears allowing the user to enter some notes. The notes are accessible to the challenge manager and may assist the challenge manager in dispensation of the episode. The user can then select a process option 512 to record the acceptance or challenge. If the accept option is selected, the file is cleared for payment and removed from the inbox. If the challenge option is selected, the file is sent to the Challenge Manager for further review and removed from the inbox. If an episode is challenged and returned to the provider, it returns the inbox as a pending decision. The subject matter expert can review details regarding the status of the file to assist in making a decision.

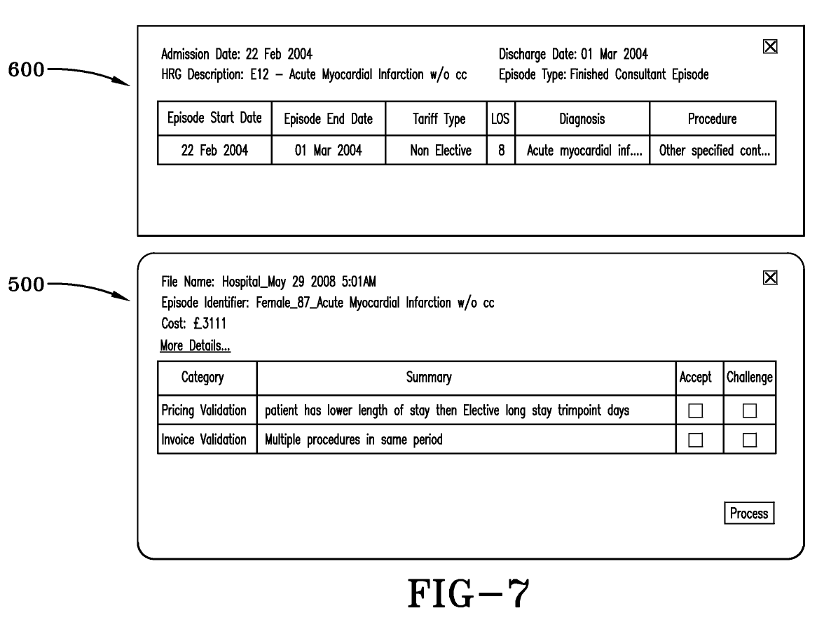

Referring to FIG. 7, a more episode details screen is shown. The additional details are provided in a portion of the screen 600 above the details portion of the screen 500. The user may view the admission date, discharge date, healthcare resource group description and episode type. The user may also review the episode start and end dates, tariff type, length of stay (LOS), diagnosis, and procedure. This additional information may assist the user in deciding whether to accept or challenge the episode.

Users may also view various reports related to episodes and their dispositions as recorded in the database. Report options include performance/resource utilization reports, challenge reports, trend reports, and financial reconciliation reports.

While certain embodiments of the present invention are described in detail above, the scope of the invention is not to be considered limited by such disclosure, and modifications are possible without departing from the spirit of the invention as evidenced by the claims.

APPENDIX A
Example Rule Categories

| Rule Grouping | Event/Activity/Operation |
|---|---|
| Data Quality | National Required fields completed, (Commissioning minimum data set) |
| | Locally required fields complete (Payor Specific) |
| | Fields meet input criteria |
| Patient and GP Eligibility | Patient and GP belong to specific payor |
| | Return out of area patients/ineligible GP to provider Detect MOD activity |
| | Foreign visitors (no reciprocal agreement) |
| Duplicate Checking | Remove double counts of activity in month |
| | Detect Activity previously submitted or paid for |
| | Detect changes to previously submitted activity |
| Clinical Validation | Payor specific Interventions not normally funded (INNF)/Low priority |
| | procedures |
| | Inconsistent diagnosis/treatment (right coding) incorrect matching codes to |
| | gender type etc. |
| | Elective/non elective claims (A&E admits to meet 4 hrs) |
| | Detect activity relating to centrally commissioned service |
| | Trend Activity levels against contract levels (Over/under per) |
| Invoice Validation | Check Trim points |
| | Check HRG, Grouper, or Spell data per NHS |
| | Review Length of stay/excess bed days |
| | Meet Local agreements/contract terms |
| | Check against PBC PbR payment agreements (clinics, etc) |
| | Review against Performance bonuses/discounts |
| | Remove national funded program initiatives |
| | Manual calculations where necessary |
| Pricing Adjustments | Flex points |
| | Identify claims arising from accident/subrogation claims |
| | Payment Agreement |
| Pricing Resolution | Trimpoints |
| | HRG, Grouper, or Spell data per NHS |
| | Length of stay |
| | Meet Local agreements/contract terms |
| | PBC PbR payment agreements (clinics, etc) |
| | Performance bonuses |
| | National provider payment initiatives |
| Settlement/Adjustment to | Freeze point |
| monthly advance payment | Payment to provider |
| Financial recovery or | Claims to be paid under national programs (payor to claim) |
| Subrogation | Claims arising from accident/subrogation claims |
| | Foreign Visitors (Check that there is a claim back process for countries |
| | with a reciprocal agreement). |

APPENDIX B
Example Rule Listing

| | Rule | | | | | | |
|---|---|---|---|---|---|---|---|
| Rules | Grouping | Decision | Challenge | OP | FCE | AE | Rule Algorithm |
| Missing | Data Quality | | Y | Y | Y | Y | Input Provider Identifier |
| Provider | | | | | | | does not exist |
| Identifier | | | | | | | |
| Contract | Data Quality | | Y | Y | Y | Y | |
| Details not | | | | | | | |
| available for | | | | | | | |
| payor/Provider | | | | | | | |
| Local Tariffs | Data Quality | | Y | Y | Y | Y | |
| not available | | | | | | | |
| for payor/Provider | | | | | | | |
| Missing NHS | Data Quality | | Y | Y | Y | Y | Input unique Patient |
| Numbers or | | | | | | | Identifier does not exist |
| Unique | | | | | | | |
| Patient | | | | | | | |
| Identifier | | | | | | | |
| Missing | Data Quality | | Y | Y | Y | | Input diagnosis code |
| Diagnosis/ | | | | | | | (ICD-10) and procedure |
| Procedure | | | | | | | code(OPCS4 code) does |
| code for FCE | | | | | | | not exist for FCE Episode |
| Diagnosis | Clinical | | Y | | Y | | Input diagnosis code is |
| codes are | Validation | | | | | | not a valid ICD-10 code |
| from | | | | | | | for FCE Episode |
| appropriate | | | | | | | |
| ICD-10 code | | | | | | | |
| set for FCE | | | | | | | |
| Procedure | Clinical | | Y | | Y | | Input procedure code is |
| codes are | Validation | | | | | | not valid OPCS4 code for |
| from | | | | | | | FCE episode |
| appropriate | | | | | | | |
| OPCS set | | | | | | | |
| (OPCS-4.2 | | | | | | | |
| for HRG v3.5) | | | | | | | |
| (OPCS-4.3 or | | | | | | | |
| OPCS-4.4 for | | | | | | | |
| HRG4) for | | | | | | | |
| FCE | | | | | | | |
| Missing | Data Quality | | Y | | Y | | Input Discharge Date |
| Admission/ | | | | | | | does not exist for FCE |
| Discharge | | | | | | | Episode |
| date for FCE | | | | | | | |
| Missing | Data Quality | | Y | | Y | | Input Admission Type |
| Admission | | | | | | | does not exist for FCE |
| Type for FCE | | | | | | | Episode |
| Admission | Data Quality | | Y | | Y | | Discharge Date cannot |
| Date cannot | | | | | | | be less than Admit Date |
| be greater | | | | | | | |
| than | | | | | | | |
| Discharge | | | | | | | |
| Date for FCE | | | | | | | |
| HRG Tariffs | Data Quality | | Y | | Y | | Input HRG has no tariff |
| not available | | | | | | | provided for FCE Episode |
| for Spell | | | | | | | |
| Costing for | | | | | | | |
| FCE | | | | | | | |
| Missing Age | Data Quality | | Y | Y | Y | Y | Input age does not exist |
| for FCE/OP | | | | | | | for FCE episode |
| Missing Legal | Data Quality | | Y | | Y | | Input Legal Status does |
| Status for | | | | | | | not exist for FCE episode |
| FCE | | | | | | | |
| Missing HRG | Data Quality | | Y | | | Y | Input HRG3.2 code does |
| 3.2 code for | | | | | | | not exist for AE episode |
| AE | | | | | | | |
| Missing | Data Quality | | Y | Y | | Y | Input Attendance Type |
| Attendance | | | | | | | does not exist for AE or |
| Type for | | | | | | | OP episode |
| AE/OP | | | | | | | |
| Missing | Data Quality | | Y | | | Y | Input Attendance Date for |
| Attendance | | | | | | | Episode Type AE |
| Date for AE | | | | | | | |
| Missing | Data Quality | | Y | Y | | | Input Arrival Date for |
| Arrival Date | | | | | | | Episode Type OP |
| for OP | | | | | | | |
| Missing Age | Data Quality | | Y | Y | | | Input age for OP episode |
| at Attendance | | | | | | | |
| for OP | | | | | | | |
| Unidentified | Data Quality | | Y | Y | | | Input Specialty Code for |
| specialty/ | | | | | | | Episode Type OP |
| Treatment | | | | | | | |
| Function | | | | | | | |
| Codes for OP | | | | | | | |
| Age not | Clinical | Y | | Y | Y | Y | Input Age is not valid for |
| matching age | Validation | | | | | | HRG (List of valid HRG) |
| sensitive | | | | | | | |
| HRGs | | | | | | | |
| Procedure | Clinical | | Y | Y | Y | Y | Input Procedure or |
| Code/Diagnosis | Validation | | | | | | Diagnosis Code is not |
| Code | | | | | | | relevant for this Episode |
| not relevant | | | | | | | Type |
| for the case | | | | | | | |
| Charges for | Clinical | Y | | Y | Y | Y | |
| activity where | Validation | | | | | | |
| payor is not | | | | | | | |
| the | | | | | | | |
| responsible | | | | | | | |
| commissioner | | | | | | | |
| High cost | Finance | Y | | Y | Y | Y | Input episode cost is |
| patients | Validation | | | | | | more than £10000 |
| (>10K | | | | | | | |
| pounds) | | | | | | | |
| HRG Code | Clinical | Y | | | Y | | Input HRG Code N12 |
| N12 - anti- | Validation | | | | | | should be treated as OP |
| natal less | | | | | | | if duration is less than 4 |
| than 4 hours | | | | | | | Hours |
| should be | | | | | | | |
| treated as OP | | | | | | | |
| rather than | | | | | | | |
| FCE | | | | | | | |
| OP | Finance | Y | | | Y | | Processed episode type |
| attendance | Validation | | | | | | is OP in FCE spell |
| during FCE | | | | | | | |
| spell | | | | | | | |
| Duplicate | Data Quality | | Y | Y | Y | Y | Input episode is duplicate |
| Episode | | | | | | | of episode (Display |
| records | | | | | | | episode Id) |
| First and | Finance | Y | | Y | | Y | Input First and Followup |
| Followup | Validation | | | | | | attendance date is same |
| attendance | | | | | | | for OP/AE Episode |
| on same day | | | | | | | |
| for AE/OP | | | | | | | |
| N12 spells | Finance | Y | | Y | | Y | Input episode cost is |
| above the | Validation | | | | | | more than £10000 |
| national | | | | | | | |
| average HES | | | | | | | |
| data for | | | | | | | |
| same/prior | | | | | | | |
| year | | | | | | | |
| Charges for | Finance | Y | | Y | Y | Y | Processed episode has |
| non-elective | Validation | | | | | | chemotherapy HRG on it |
| chemotherapy | | | | | | | |
| spell | | | | | | | |
| Check for | Clinical | Y | | Y | Y | | HRG Exclusion list |
| Procedures | Validation | | | | | | contain the procedures |
| which will not | | | | | | | code for exclusion |
| be paid for | | | | | | | |
| Check | Clinical | Y | | | Y | | LoS compared with |
| patients with | Validation | | | | | | average length of stay for |
| very long LoS | | | | | | | particular HRG |
| compared to | | | | | | | |
| National | | | | | | | |
| Average | | | | | | | |
| If LoS = 2 | Finance | Y | | | Y | Y | |
| days instead | Validation | | | | | | |
| of actual | | | | | | | |
| (e.g., 10 | | | | | | | |
| days), full | | | | | | | |
| payment of | | | | | | | |
| HRG instead | | | | | | | |
| of approx | | | | | | | |
| 20%. | | | | | | | |
| Input | Clinical | Y | | Y | | | Outpatient Tariff list |
| Outpatient | Validation | | | | | | contain detail for first and |
| cost applies | | | | | | | follow up tariff for specific |
| for follow up | | | | | | | Specialty Code |
| attendances | | | | | | | |
| where as | | | | | | | |
| input | | | | | | | |
| attendance | | | | | | | |
| type is first | | | | | | | |
| attendance. | | | | | | | |
| Elective | Finance | | | | Y | | Compare elective |
| inpatient | Validation | | | | | | inpatient last discharge |
| readmissions | | | | | | | date with readmission |
| within 14 | | | | | | | date |
| days of a | | | | | | | |
| patient being | | | | | | | |
| discharged | | | | | | | |
| Non | Finance | | | | | Y | Compare |
| elective/emergency | Validation | | | | | | elective/emergency |
| readmissions | | | | | | | inpatient last discharge |
| within 14 | | | | | | | date with readmission |
| days of a | | | | | | | date |
| patient being | | | | | | | |
| discharged | | | | | | | |
| Patients with | Clinical | | Y | | y | | a) Input Episode already |
| two or more | Validation | | | | | | exists from the same |
| admissions | | | | | | | EpisodeType |
| on same day | | | | | | | b) Input Patient with |
| | | | | | | | Episode already having |
| | | | | | | | another episode for the |
| | | | | | | | input admission date |
| OP same day | Clinical | | Y | Y | ? | | a) Input OP Episode |
| as elective | Validation | | | | | | already exists with same |
| admission | | | | | | | ‘Elective’ admission type |
| | | | | | | | and same admission |
| | | | | | | | dates |
| | | | | | | | b) Input Patient with OP |
| | | | | | | | Episode already having |
| | | | | | | | another OP episode for |
| | | | | | | | the input admission date |
| | | | | | | | c) Input Patient with Non- |
| | | | | | | | OP Episode for the |
| | | | | | | | input admission date |
| Follow up OP | Clinical | Y | | Y | | | a) Input OP Episode |
| with 2 or | Validation | | | | | | already exists with same |
| more | | | | | | | ‘FollowUp’ admission |
| attendances | | | | | | | type and same admission |
| on same day | | | | | | | dates |
| | | | | | | | b) Input Patient with OP |
| | | | | | | | Episode already having |
| | | | | | | | another OP episode for |
| | | | | | | | the input admission date |
| | | | | | | | c) Input Patient with Non- |
| | | | | | | | OP Episode for the |
| | | | | | | | input admission date |
| Chemotherapy | Finance | Y | | Y | Y | | Input Admission Type as |
| done | Validation | | | | | | Emergency and validate |
| as Elective | | | | | | | the right Admission Type |
| not | | | | | | | (Emergency) for selected |
| Emergency | | | | | | | diagnosis (e.g., |
| | | | | | | | Chemotherapy) |
| First OP with | Data Quality | | Y | Y | | | |
| 2 or more | | | | | | | |
| attendances | | | | | | | |
| on same day | | | | | | | |
| Surgical | Data Quality | | Y | Y | Y | Y | Surgical admission with |
| admission | | | | | | | ‘Non-Elective’ must have |
| (admission | | | | | | | mandatory procedure |
| type) with no | | | | | | | codes |
| procedure | | | | | | | |
| (non-elective) | | | | | | | |
| Surgical | Data Quality | | Y | | Y | Y | Surgical admission with |
| admission | | | | | | | ‘Elective’ must have |
| (admission | | | | | | | mandatory procedure |
| type) with no | | | | | | | codes |
| procedure | | | | | | | |
| (elective) | | | | | | | |
| Practice | Clinical | Y | | Y | Y | Y | Input Practice code for |
| registration is | Validation | | | | | | the same payor (OrgId) |
| within payor | | | | | | | |
| OP same day | Clinical | Y | | Y | | | a) Input OP Episode |
| as NEW | Validation | | | | | | already exists with |
| | | | | | | | Attendance Type as |
| | | | | | | | “First Attendance” and |
| | | | | | | | same admission dates |
| | | | | | | | b) Input Patient with OP |
| | | | | | | | Episode already having |
| | | | | | | | another OP episode for |
| | | | | | | | the input attendance date |
| | | | | | | | c) Input Patient with Non- |
| | | | | | | | OP Episode for the |
| | | | | | | | input attendance date |
| OP same day | Clinical | Y | | Y | | | a) Input OP Episode |
| as FU (same | Validation | | | | | | already exists with |
| specialty | | | | | | | Attendance Type as |
| only) | | | | | | | ‘Follow-up Attendance’ |
| | | | | | | | and same admission |
| | | | | | | | dates |
| | | | | | | | b) Input Patient with OP |
| | | | | | | | Episode already having |
| | | | | | | | another OP episode for |
| | | | | | | | the input attendee date |
| | | | | | | | c) Input Patient with Non- |
| | | | | | | | OP Episode for the |
| | | | | | | | input attendance date |
| OP FUs | Data Quality | Y | | Y | | | Input OP Episode already |
| coded as 1st | | | | | | | exists with Attendance |
| OP (special | | | | | | | Type as “First & Follow- |
| focus on | | | | | | | Up Attendance” |
| Obstetric | | | | | | | |
| multiple | | | | | | | |
| attendances) | | | | | | | |
| Check N12 | Clinical | Y | | Y | Y | Y | |
| codes | Validation | | | | | | |
| reclassification | | | | | | | |
| of | | | | | | | |
| elective into | | | | | | | |
| FU | | | | | | | |
| attendance | | | | | | | |
| (HES data v | | | | | | | |
| local data) | | | | | | | |
| Check for | Data Quality | Y | | Y | Y | Y | a) Input FCE Episode |
| patients with | | | | | | | already exists with same |
| more than | | | | | | | admission dates |
| one spells on | | | | | | | b) Input Patient with FCE |
| the same day | | | | | | | Episode already having |
| | | | | | | | another FCE episode for |
| | | | | | | | the input attendance date |
| Ensure | Finance | | Y | Y | Y | Y | |
| Specialist | Validation | | | | | | |
| Commissioning | | | | | | | |
| is not | | | | | | | |
| included in | | | | | | | |
| contract | | | | | | | |
| Check if day | Finance | | Y | Y | Y | Y | |
| cases should | Validation | | | | | | |
| be charged | | | | | | | |
| as OPs under | | | | | | | |
| PbR | | | | | | | |
| guidance | | | | | | | |
| Check high | Finance | | Y | Y | Y | Y | |
| cost drugs | Validation | | | | | | |
| against | | | | | | | |
| contract to | | | | | | | |
| ensure not | | | | | | | |
| duplicated | | | | | | | |
| Specialist | Finance | Y | | Y | | Y | Input the HRG and check |
| Top Up | Validation | | | | | | Eligibility for specialized |
| incorrectly | | | | | | | tariff top up in APC Tariff |
| applied to | | | | | | | |
| excess Bed | | | | | | | |
| Day charge | | | | | | | |
| Multiple | Finance | Y | | Y | Y | Y | Input the procedure code |
| procedures in | Validation | | | | | | for the specific time |
| same period | | | | | | | duration from Episode |
| Calculation of | Finance | Y | | | Y | Y | |
| critical Care | Validation | | | | | | |
| bed days | | | | | | | |
| correct | | | | | | | |
| Complex | Finance | Y | | Y | | | |
| treatment | Validation | | | | | | |
| charged as | | | | | | | |
| day cases | | | | | | | |
| Trim point | Finance | Y | | Y | | Y | To verify Trim Point & |
| and specialty | Validation | | | | | | Specialty code in APC |
| code rules | | | | | | | Tariff & FCE |
| have been | | | | | | | |
| applied | | | | | | | |
| Elective | Finance | Y | | | Y | Y | Input the HRG and |
| Inpatient with | Validation | | | | | | compare Elective long |
| stay 10 days | | | | | | | stay trim point days for |
| trim point | | | | | | | specialized tariff top up in |
| | | | | | | | APC Tariff |
| Inpatient | Finance | Y | | | Y | Y | Input the HRG and |
| admission | Validation | | | | | | compare Elective long |
| >10 days | | | | | | | stay trim point days for |
| above trim | | | | | | | specialized tariff top up in |
| point | | | | | | | APC Tariff |
| Identify and | Finance | Y | | | Y | Y | Input the HRG and |
| check | Validation | | | | | | compare Elective long |
| elective | | | | | | | stay trim point days for |
| patients with | | | | | | | specialized tariff top up in |
| low length of | | | | | | | APC Tariff |
| stay in HRG | | | | | | | |
| with low trim | | | | | | | |
| point | | | | | | | |
| Inpatient | Finance | Y | | | Y | Y | Input the HRG and |
| length of | Validation | | | | | | compare Elective long |
| stays | | | | | | | stay trim point days for |
| significantly | | | | | | | specialized tariff top up in |
| higher than | | | | | | | APC Tariff |
| the HRG trim | | | | | | | |
| point | | | | | | | |
| Identify and | Finance | Y | | | Y | Y | Input the HRG and |
| check | Validation | | | | | | compare Elective long |
| elective | | | | | | | stay trim point days for |
| patients with | | | | | | | specialized tariff top up in |
| low length of | | | | | | | APC Tariff |
| stay in HRG | | | | | | | |
| with high trim | | | | | | | |
| point | | | | | | | |

What is claimed is:

1. A system for settling and validating invoices for healthcare services comprising:
a database comprising:
(a) data quality rules for identifying incomplete or inaccurate data in episode data for an episode related to a single patient care event;
(b) clinical validation rules for determining healthcare services provider compliance with national and local standards of patient care established by a payor;
(c) financial validation rules for determining healthcare services provider charges comply with national and local financial requirements established by said payor;
a server for receiving from a healthcare services provider computer episode data related to a single patient care event, said episode data comprising clinical data related to patient care provided by said healthcare services provider and financial data related to charges for patient care provided by said healthcare services provider;
a settlement and invoice validation application at said server for:
(a) applying at least one of said data quality rules to said episode data to identify incomplete or inaccurate data in episode data;
(b) rejecting said episode data if said at least one data quality rule identifies incomplete or inaccurate data in said episode data;
(c) applying at least one of said clinical validation rules to determine healthcare services provider compliance with national and local standards of patient care established by said payor;
(d) rejecting said episode data if application of said at least one of said clinical validation rules determines said healthcare services provider failed to comply with national or local standards of patient care established by said payor;
(e) applying at least one financial validation rule to determine said healthcare services provider charges comply with national and local financial requirements established by said payor;
(f) rejecting said episode data if application of said at least one of said financial validation rules determines said healthcare services provider charges failed to comply with national or local financial requirements established by said payor;
(g) accepting said episode data for payment if said episode data is not rejected according to said data quality rules, said clinical rules or said financial rules; and
(h) if said episode data is rejected according to said data quality rules, said clinical rules or said financial rules;
(i) marking said episode data for challenge; and
(ii) forwarding said episode data for action by a payor representative.

2. The system of claim 1 wherein forwarding said episode data for action by a payor representative comprises forwarding said episode data to an electronic inbox.

3. The system of claim 1 wherein said payor representative is a clinical subject matter expert if said episode data is rejected for failure to comply with said clinical validation rules.

4. The system of claim 1 wherein said payor representative is a financial subject matter expert if said episode data is rejected for failure to comply with said financial validation rules.

5. The system of claim 2 further comprising forwarding said episode data to a challenge manager that decides whether to accept or challenge said episode following said action by said payor representative.

6. A method for settling and validating invoices for healthcare services comprising:
(a) entering in a database:
(i) data quality rules for identifying incomplete or inaccurate data in episode data for an episode related to a single patient care event;
(ii) clinical validation rules for determining healthcare services provider compliance with national and local standards of patient care established by a payor;
(iii) financial validation rules for determining healthcare services provider charges comply with national and local financial requirements established by said payor;
(b) receiving at a server from a healthcare services provider computer episode data related to a single patient care event, said episode data comprising clinical data related to patient care provided by said healthcare services provider and financial data related to charges for patient care provided by said healthcare services provider;
(c) applying at least one of said data quality rules to said episode data to identify incomplete or inaccurate data in episode data;
(d) rejecting said episode data if said at least one data quality rule identifies incomplete or inaccurate data in said episode data;
(e) applying at least one of said clinical validation rules to determine healthcare services provider compliance with national and local standards of patient care established by said payor;
(f) rejecting said episode data if application of said at least one of said clinical validation rules determines said healthcare services provider failed to comply with national or local standards of patient care established by said payor;
(g) applying at least one financial validation rule to determine said healthcare services provider charges comply with national and local financial requirements established by said payor;
(h) rejecting said episode data if application of said at least one of said financial validation rules determines said healthcare services provider charges failed to comply with national or local financial requirements established by said payor;
(i) accepting said episode data for payment if said episode data is not rejected according to said data quality rules, said clinical rules or said financial rules; and
(j) if said episode data is rejected according to said data quality rules, said clinical rules or said financial rules;
(i) marking said episode data for challenge; and
(ii) forwarding said episode data for action by a payor representative.

7. The method of claim 6 wherein forwarding said episode data for action by a payor representative comprises forwarding said episode data to an electronic inbox.

8. The method of claim 6 wherein said payor representative is a clinical subject matter expert if said episode data is rejected for failure to comply with said clinical validation rules.

9. The method of claim 6 wherein said payor representative is a financial subject matter expert if said episode data is rejected for failure to comply with said financial validation rules.

10. The method of claim 6 further comprising forwarding said episode data to a challenge manager that decides whether to accept or challenge said episode following said action by said payor representative.
